(19) United States
(12) Patent Application Publication
(10) Pub. No.: US 2006/0136523 A1
(43) Pub. Date: Jun. 22, 2006

(54) Program packing systems

(75) Inventor: Che Liang Lien, Taichung (TW)

Correspondence Address: QUINTERO LAW OFFICE, 1617 BROADWAY, 3RD FLOOR, SANTA MONICA, CA, 90404, US

(73) Assignee: MITAC TECHNOLOGY CORP., HSIN-CHU HSIEN (TW)

(21) Appl. No.: 11/215,145

(22) Filed: Aug. 29, 2005

(30) Foreign Application Priority Data
Dec. 22, 2004 (TW) TW93140032

(51) Int. Cl. G06F 17/30

(52) U.S. Cl. 707/204

(57) ABSTRACT

A packing system comprises a database and a server coupled thereto. The database stores a first software package comprising an original version of files comprising a first portion and a second portion. The server receives a new version of the first portion via a network, automatically produces a copy of the second portion, and automatically integrates the new version of the first portion and the copy of the second portion into a second software package.

### BACKGROUND

The invention relates to computer techniques, and in particular, to software packing utilizing network techniques.

In software development, designers have to test, debug, and modify computer programs several times for quality assurance. Typically, only a portion of the files included in a software package require update with each program modification. Designers may receive file update requests from different entities and spend time updating files during development. The more frequently the file updates are requested, the more time it takes designers to respond to the update requests. Manual file updates utilize computer user interfaces, presenting difficulties in simultaneous handling of many file update requests, often subject to error. Further, software development units in different time zones may not be able to coordinate software packing services , delaying the software development cycle.

### SUMMARY

Accordingly, methods and systems are provided.

An exemplary embodiment of program packing system comprises a database and a server coupled thereto. The database stores a first software package comprising an original version of files comprising a first portion and a second portion. The server receives a new version of the first portion via a network, automatically generates a copy of the second portion, and automatically integrates the new version of the first portion and the copy of the second portion into a second software package.

An exemplary embodiment of program packing system comprises a database and a server coupled thereto. The database stores software packages, wherein a first software package corresponding to a project comprises files. The server receives selection of the project as well as a group of files via a network, automatically searches the first software package based on the selection, automatically produces a copy of the first software package, automatically integrates the copy of the first software package and the group of files based on file names, and compresses the result of the integration into a second software package.

### DESCRIPTION OF THE DRAWINGS

The invention can be more fully understood by reading the subsequent detailed description and examples with references made to the accompanying drawings, wherein:

FIG. 1 is a schematic diagram of an exemplary embodiment of a software packing system;

FIGS. 2A-2C are flowcharts of operation of the exemplary embodiment of a software packing system;

FIG. 3 is a schematic diagram of an exemplary embodiment of a login page 50;

FIG. 4 is a schematic diagram of an exemplary embodiment of a log record page 51;

FIG. 5 is a schematic diagram of an exemplary embodiment of a project menu page 52;

FIG. 6 is a schematic diagram of an exemplary embodiment of a setting page 53;

FIG. 7 is a schematic diagram of an exemplary embodiment of a file-uploading page 54;

FIG. 8 is a schematic diagram of an exemplary embodiment of a software package 22;

FIG. 9 is a schematic diagram of an integration operation of file group 420 and software package 21; and

FIG. 10 a schematic diagram of an exemplary embodiment of a packing completion page 55.

### DETAILED DESCRIPTION

Software packing systems are provided. An exemplary embodiment thereof comprises a server and a database, which may be distinct entities coupled to each other, or integrated into one server.

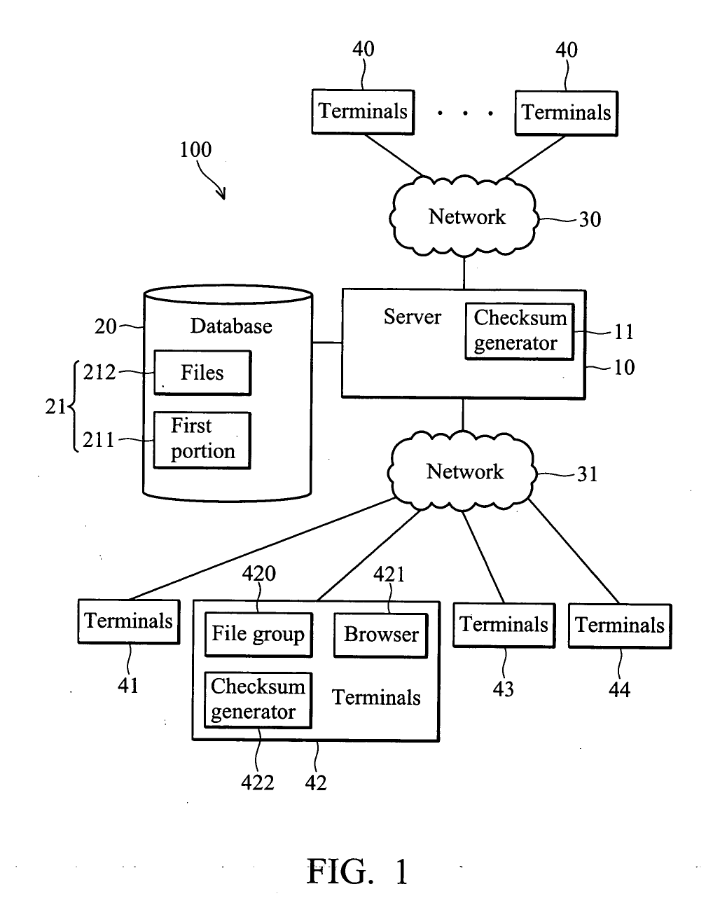

As shown in FIG. 1, server 10 is coupled to database 20, network 30 and 31. Terminals 40 are coupled to network 30. Network 31 is coupled to terminals 41-44. Terminal 40 may represent computers of customers. Terminal 41-44 may represent computers of an administrator of server 10, research and development engineers, quality assurance (QA) personnel, or product management personnel.

Server 10 may be a workstation, a web server (such as an Apache server), or a computer. Terminals 40-44 may comprise web browsers, such as web browser 421 in terminal 42. Server 10 can process Hypertext Markup Language (HTML) source codes to display Graphic User Interface (GUI) on browsers of terminals 40-44 and receive commands or data therefrom. For example, terminals 40-44 may upload data or updated files to server 10.

Database 20 stores a plurality of user accounts, passwords, and projects to which each user account ID corresponds, and software packages included in each project (such as software package 21). Each software package comprises one or more files. A portion of file group 420 in terminal 44 updates first portion 211 of software package 21. First portion 211 of software package 21 and file group 420 may comprise one or more files and respective directory structure. Each project comprises a list indicating software package component files therein. A software package with all component files therein is stored in the form of a compressed file in database 20. If a software package lacks component files, the software package is directly stored in database 20 without compression. Software packages in database 20 may comprise operating Systems (OS), applications, or other computer programs.

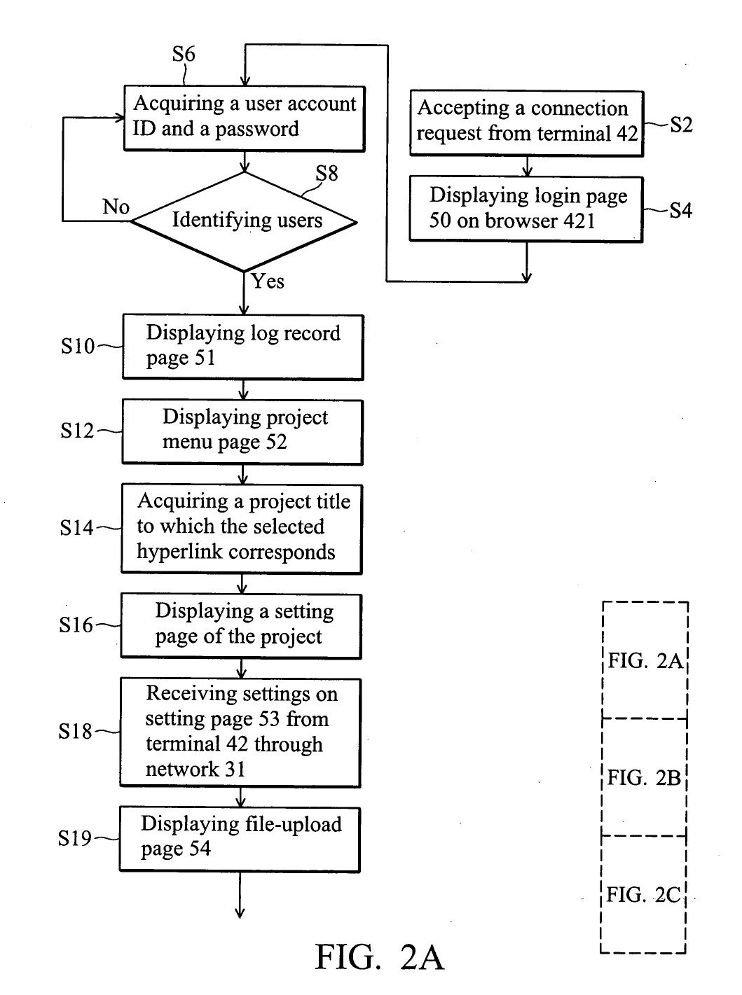

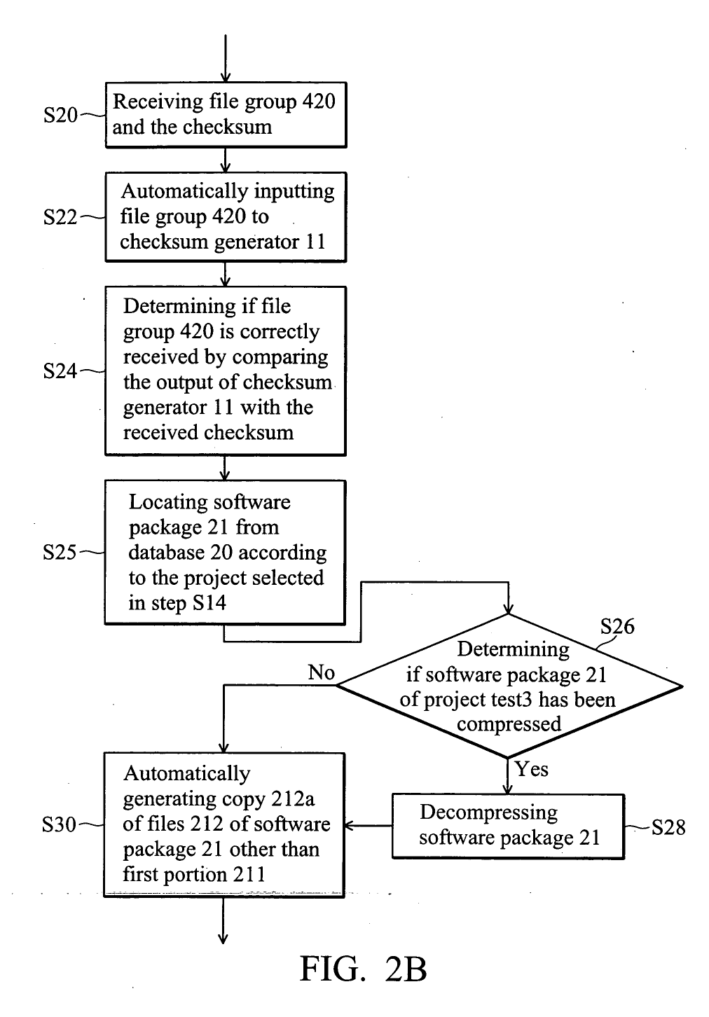

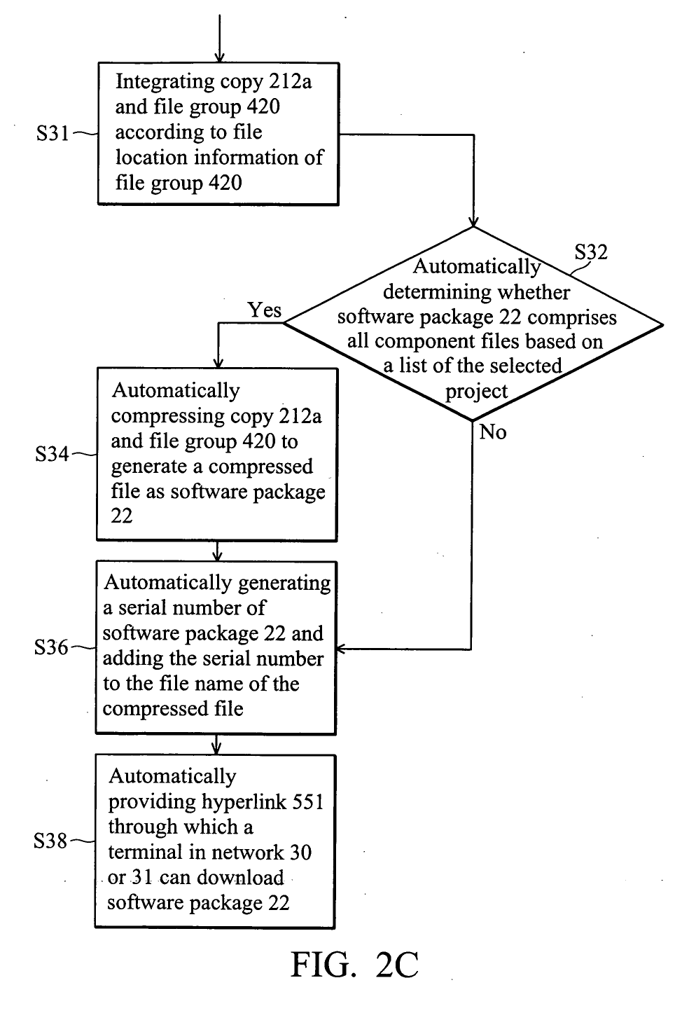

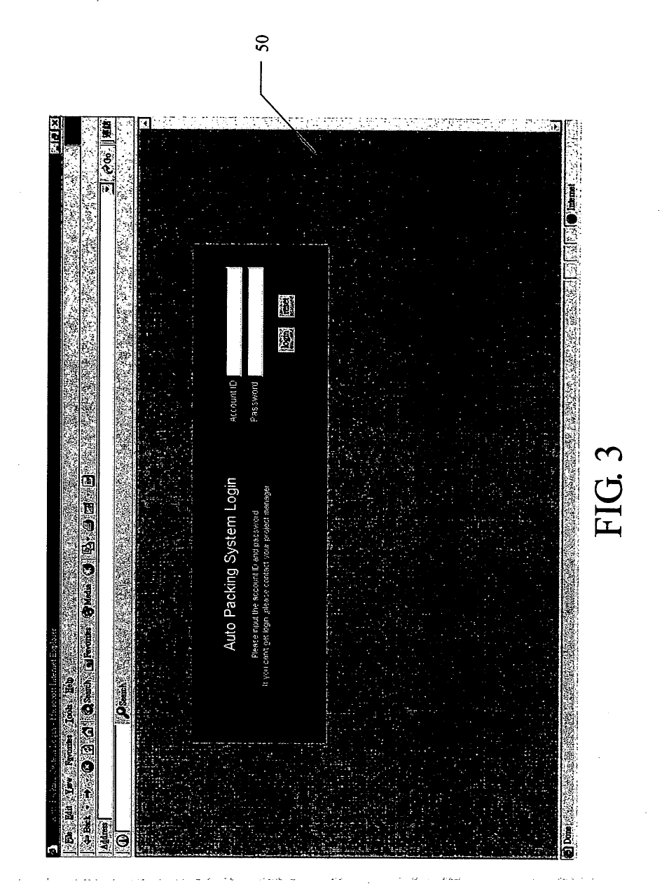

With reference to FIG. 2, terminal 42 connects, for example, to server 10. Server 10 accepts a connection request from terminal 42 (step S2) and displays login page 50 on browser 421 (step S4), as shown in FIG. 3. Login page 50 may be a webpage comprising an account ID field and a password field. Server 10 acquires a user account ID and a password (step S6) and identifies users accordingly (step S8). If the acquired user account ID and the password have a match record in database 20 and have authority to use software packing service provided by server 10, server 10 determines that the user identification has been accepted, authorizes use of the software packing service, and continues step S10. If not, step S4 is repeated.

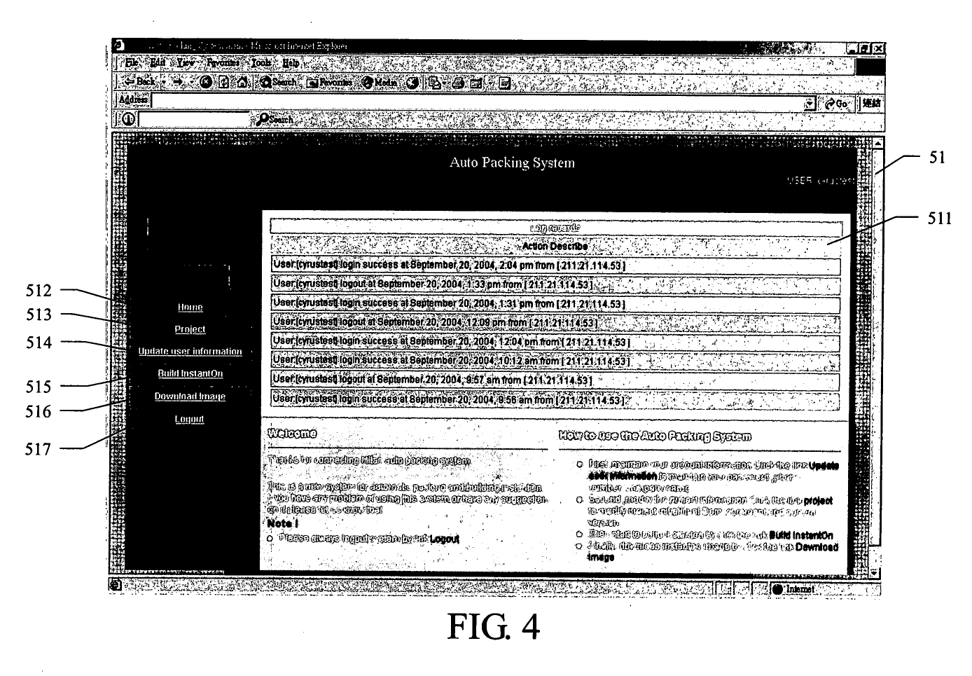

After accepting to user identification, server 10 displays log record page 51 on browser 421 (step S10), as shown in FIG. 4, comprising user account IDs (such as “cyrustest” in entry 511), login time (such as “September 20, 2004, 2:04 pm” in entry 511), and Internet Protocol (IP) addresses (such as “211.21.114.53” in entry 511) of authorized users. Six hyperlinks are shown on the left part of log record page 51. Hyperlink 512 refers to login page 50. Hyperlink 513 refers to a project editing page. Hyperlink 514 refers to a user info editing page. H refers to a project menu page. Hyperlink 516 refers to a software download page. Hyperlink 517 refers to a logout page.

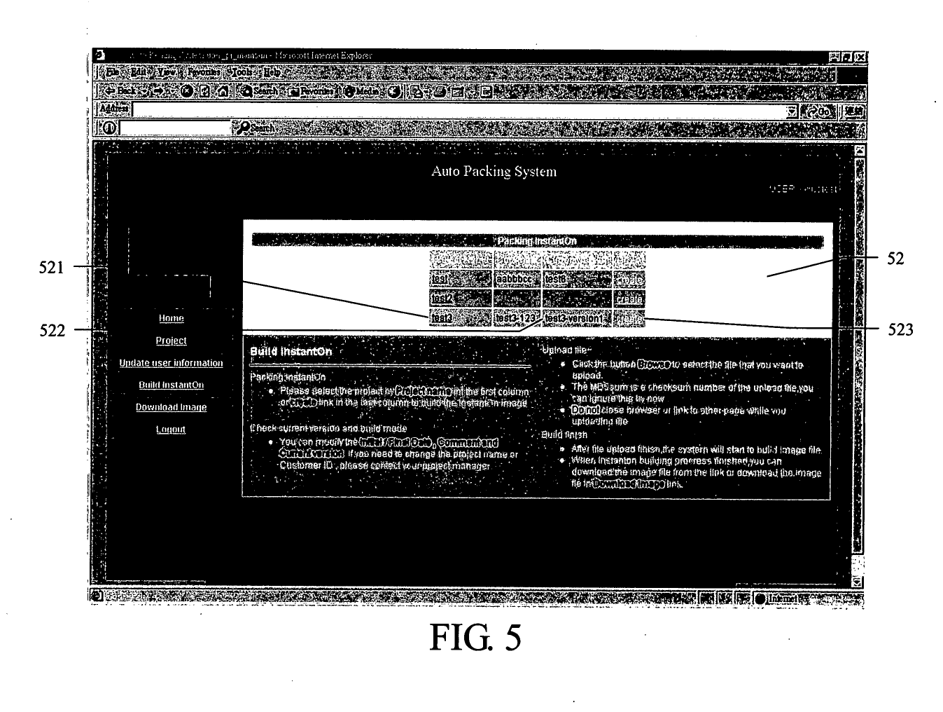

When hyperlink 515 is selected, server 10 displays project menu page 52 on browser 421 (step S12), as shown in FIG. 5, comprising project titles (such as “test3” in entry 521), versions of software packages of projects (such as “test3-versionl” in entry 522), and hyperlink 523.

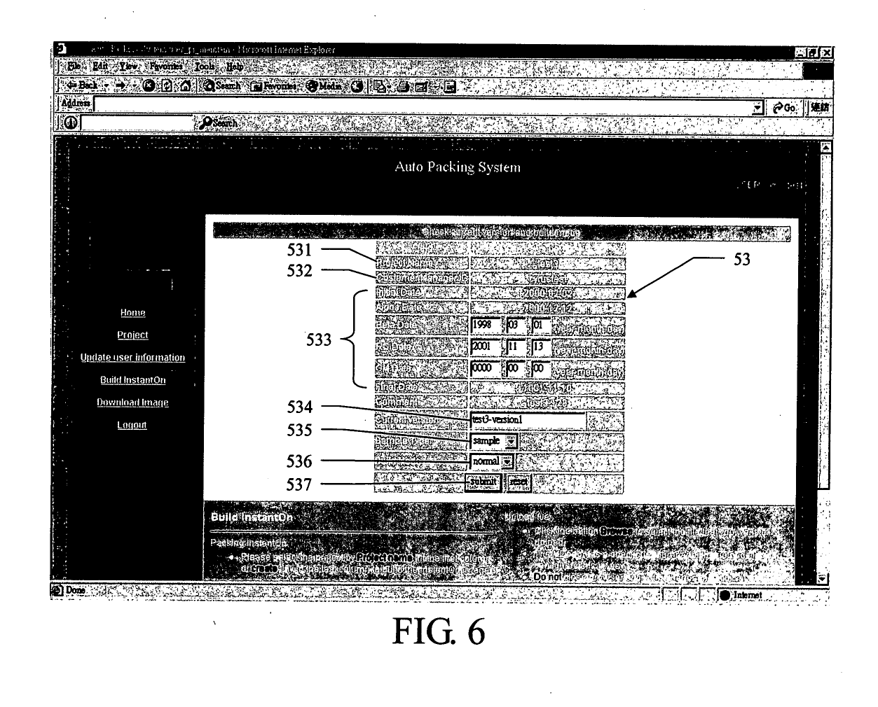

When a hyperlink (such as hyperlink 523) in project menu page 52 is selected, server 10 receives the selection from terminal 42, such as acquisition of a project title (such as “test3”) to which the selected hyperlink corresponds, (step S14) and displays a setting page (such as setting page 53) on browser 421 (step S16), as shown in FIG. 6. Setting page 53 comprises project title field 531, project manager field 532, and date fields 533. Server 10 locates a software package corresponding to a selected project.

Field 534 receives a version number of a subsequently produced software package. Check box 535 provides and receives version type options of the subsequently produced software package, such as version types suitable for various OS. Check box 536 provides and receives mode options in which the subsequently produced software package is to be generated, such as normal and debug modes.

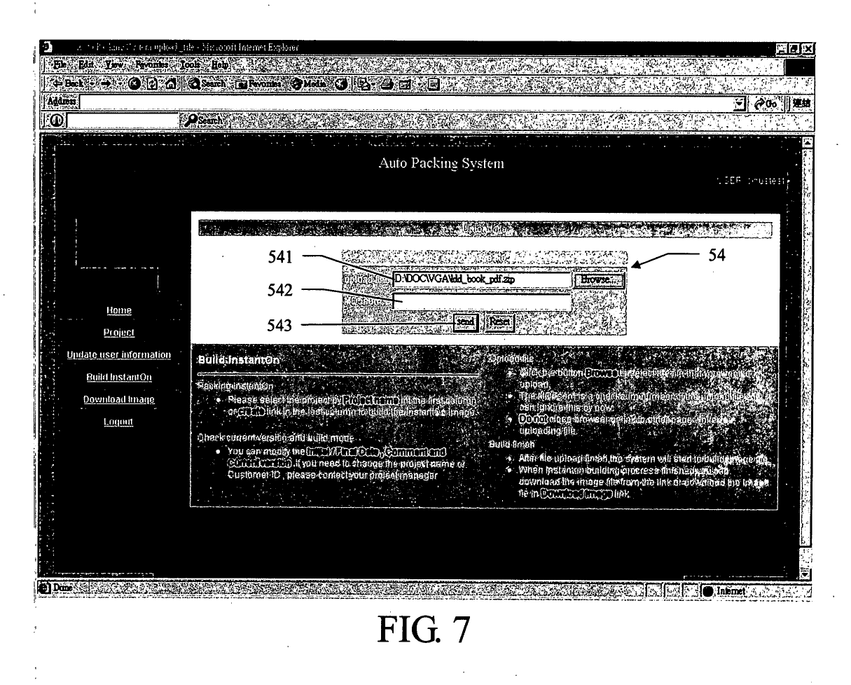

When button 537 is selected, server 10 receives settings required by setting page 53, comprising date, the version number, version type, and mode related to the subsequently produced software package (step S18). Server 10 then displays file-upload page 54 (step S19), as shown in FIG. 7. Field 541 receives the path and file name of at least one subsequently uploaded file which may comprise another version of a file of the selected project, typically a new version. For example, the subsequently uploaded file as a portion of file group 420 may used to update first portion 211 of software package 21. Field 542 receives checksum of the subsequently uploaded file which is the output of checksum generator 422 with the subsequently uploaded file as its input.

When button 543 is selected, server 10 receives file group 420 and the checksum through network 31 (step S20), automatically inputs file group 420 to checksum generator 11 (step S22), and determines if file group 420 is correctly received by comparing the output of checksum generator 11 with the received checksum (step S24). When the output is to the same as the checksum, server 10 determines that file group 420 has been correctly received and automatically performs the following steps.

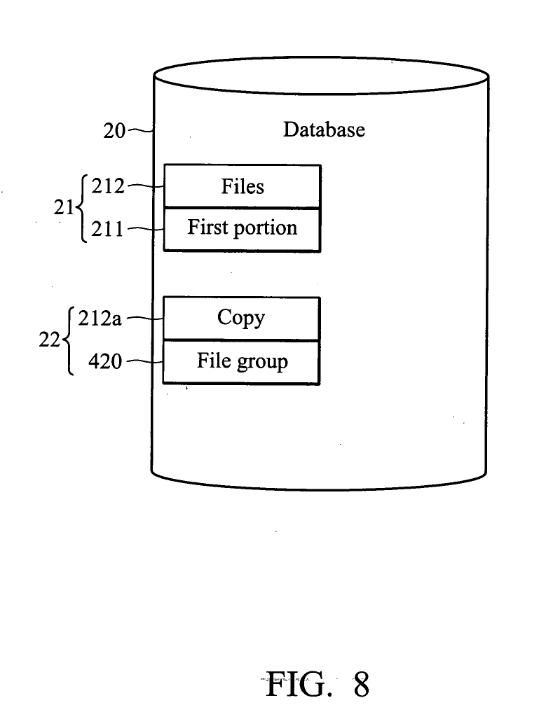

In the given example concerning project test3, server 10 locates software package 21 according to project test3 selected in step S14 (step S25), determines if software package 21 of project test3 has been compressed (step S26). If so, server 10 decompresses software package 21 (step S28). As shown in FIG. 8, server 10 automatically generates copy 212a of files 212 of software package 21 other than first portion 211 (step S30), and integrates copy 212a and file group 420 according to file location information of file group 420 (step S31). For example, server 10 can integrate copy 212a and file group 420 according to correspondence of their directory structure. For each file in file group 420, server 10 locates a file in software package 21 with the same file name. If a file is located, server 10 updates the located file in file group 420 with the file in file group 420. If not, server 10 places the file of file group 420 in software package 21 according to file location information of the file (such as the original directory of the file). Files in software package stored by server 10 satisfying a condition to be replaced by an uploaded file are referred to as corresponding files of the uploaded file. For example, the condition may be a requirement for corresponding files must have the same identification as the uploaded file, wherein the identification may comprise file name or other information. In the following description, file names are adopted as identification for updating files in software package 21 in database 20.

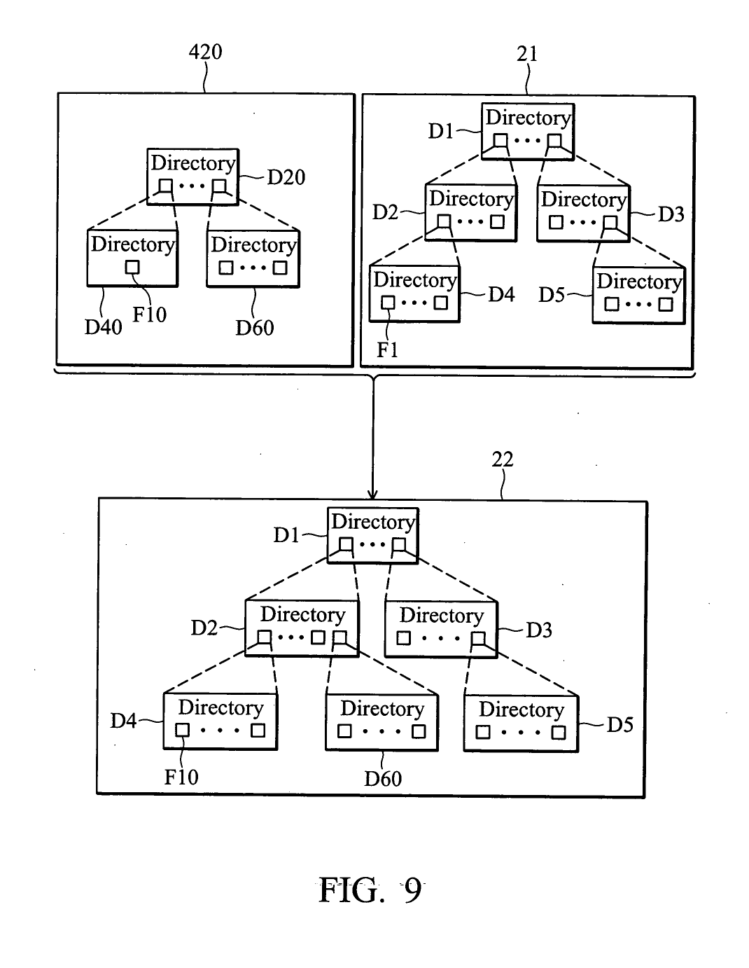

As shown in FIG. 9, hierarchical directory structure of file group 420 comprises directories D20, D40, and D60, wherein directories D20 and D40 respectively have the same directory name as directories D2 and D4 in software package 21. Server 10 reserves directories D2 and D4 in software package 21. File F10 has the same file name as file Fl, thereby corresponding thereto, and is replaced by file F10. Directory D60 and files therein not corresponding to software package 21 thus comprise new directory and files.

In step S30, server 10 duplicates files other than file Fl to generate copy 212a comprising directories Dl, D2, D3, D5, files therein, and directory D4 except file Fl and maintains original directory structure. In step S31, server 10 locates directory D2 with the same name as directory D20 and places directory 60 into directory D2 to be a subdirectory thereof, files in directory 60 into the placed directory 60. Similarly, server 10 locates directory D4 with the same name as directory D40 and places file F10 into directory D4.

Server 10 automatically determines whether software package 22 comprises all component files based on a list of the selected project (step S32). If not, step S36 is performed. If so, server 10 automatically compresses copy 212a and file group 420 to generate a compressed file as software package 22 (step S34). Software package 22 comprising copy 212a and file group 420 may conform to International Organization for Standardization (ISO) compression file format.

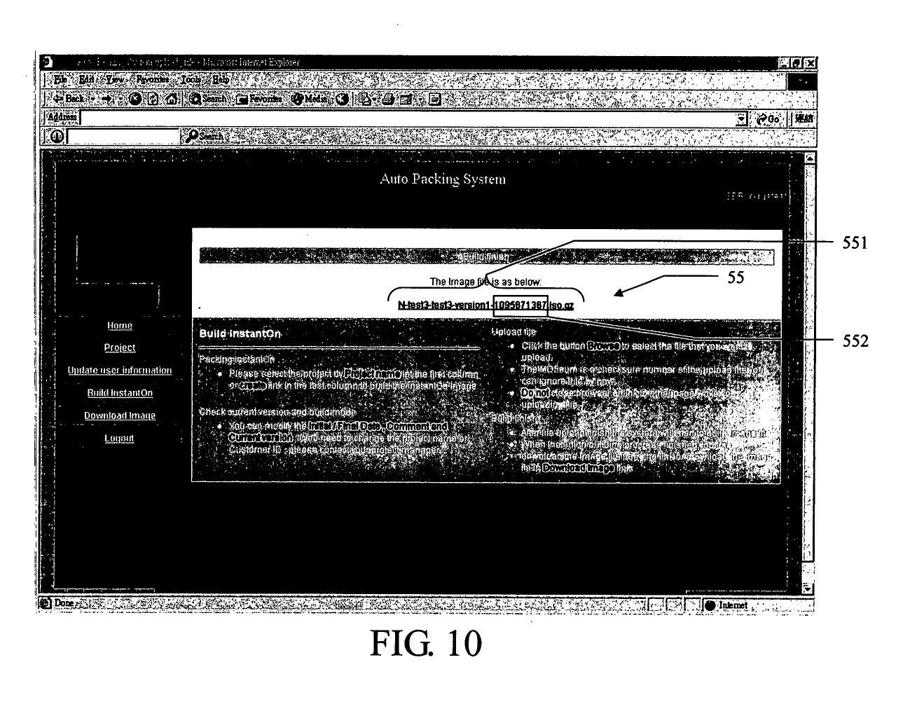

Server 10 automatically generates a serial number of software package 22 (such as serial number 522 in FIG. 10) and add the serial number to the file name (such as the text of hyperlink 551 in FIG. 10) of the generated file (such as the compressed file)to discriminate software package 22 from others (step S36). Server 10 displays packing completion page 55 and automatically provides hyperlink 551 through which a terminal in network 30 or 31 can download software package 22 (step S38). Note that server 10 may provide interfaces of other types for software package download.

When simultaneously receiving a plurality of requests, server 10 performs the software packing operations by multitasking. When simultaneously receiving a plurality of update requests for software package 21 from different account IDs, server 10 generates updated versions of software package 21 by multitasking.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A program packing system, comprising:
a database storing a first software package comprising an original version of files comprising a first portion and a second portion; and
a server coupled with the database, receiving a new version of the first portion via a network, automatically producing a copy of the second portion, and automatically integrating the new version of the first portion and the copy of the second portion into a second software package.

2. The system as claimed in claim 1, wherein the second software package is a compressed file, and the server further automatically compresses the new version of the first portion and the copy of the second portion into the compressed file.

3. The system as claimed in claim 2, wherein the server automatically determines whether the second software package comprises all component files on a list, and thereby whether to compress the new version of the first portion and the copy of the second portion is determined.

4. The system as claimed in claim 1, wherein the server automatically determines whether the first software package is a compressed file and if so, automatically decompresses the first software package.

5. The system as claimed in claim 1, wherein the server automatically generates a serial number corresponding to the second software package, thereby isolating the second software package.

6. The system as claimed in claim 1, wherein the server automatically provides an interface allowing a terminal on the network to download the second software package.

7. The system as claimed in claim 1, wherein the server receives a checksum of the new version of the first portion, inputs the new version of the first portion to a checksum generator, and determines if the new version of the first portion has been correctly received by comparing the output of the checksum generator with the received checksum.

8. The system as claimed in claim 1, wherein the server generates a plurality of new versions of the first software package by multitasking, comprising the second software package.

9. The system as claimed in claim 1, wherein the server receives the new version of the first portion and a second file via the network, the second file has no corresponding file in the first software package, and the server automatically places the second file in the second software package.

10. The system as claimed in claim 1, wherein the server integrates the new version of the first portion and the copy of the second portion according to directory structure of the new version of the first portion.

11. A program packing system, comprising:
a database storing software packages, a first software package of which corresponding to a project comprises files; and
a server coupled to the database, receiving selection of the project as well as a group of files via a network, automatically locating the first software package based on the selection, automatically producing a copy of the first software package, automatically integrating the copy of the first software package and the group of files based on file names, and compressing the result of integration into a second software package.

12. The system as claimed in claim 11, wherein the group of files comprises a second file having the same file name as a first file of the first software package, and the second software package comprises the second file rather than the first file.

13. The system as claimed in claim 11, wherein the group of files comprises a second file having a file name different from those of the first software package, and the second software package comprises the second file.

14. The system as claimed in claim 11, wherein the server integrates the copy of the first software package and the group of files based on file paths of the group of files and directory structure of the copy of the first software package.

15. The system as claimed in claim 11, wherein the server automatically determines whether the second software package comprises all component files on a list, and thereby whether to compress the result of the integration is determined.

16. The system as claimed in claim 11, wherein the server automatically determines whether the first software package is a compressed file and automatically decompresses the first software package when the first software package is a compressed file.

17. The system as claimed in claim 11, wherein the server automatically provides an interface allowing a terminal on the network to download the second software package.

18. The system as claimed in claim 11, wherein the server receives a checksum of the group of files, inputs the group of files to a checksum generator, and determines if the group of files is correctly received by comparing the output of the checksum generator with the received checksum.
